(19) United States
(12) Patent Application Publication
(10) Pub. No.: US 2015/0274388 A1
(43) Pub. Date: Oct. 1, 2015

(54) NOVEL PORTABLE SECURE STORAGE DEVICES

(71) Applicant: SnoopGuard LLC, Tampa, FL (US)

(72) Inventor: Graeme Gordon, Tampa, FL (US)

(21) Appl. No.: 14/672,106

(22) Filed: Mar. 28, 2015

Related U.S. Application Data
(60) Provisional application No. 61/972,258, filed on Mar. 29, 2014.
(60) Provisional application No. 61/994,120, filed on May 16, 2014.

(51) Int. Cl. B65D 50/00; G06K 7/10; E05B 47/00; E05B 65/52; E05B 63/00

(52) U.S. Cl. CPC B65D 50/00; E05B 65/52; E05B 63/00; E05B 47/00; G06K 7/10376; E05B 2047/0072; E05B 2047/005; E05B 2047/0067

(57) ABSTRACT

A system for securely storing material is provided that includes at least one canister assembly for containing material that may be retained in a portable safe that includes a closure and an internal pressure control system and has an interior space sized and shaped for retaining the canister assembly. The closure includes an access control system for locking the at least one canister assembly within the portable safe and includes at least one means for allowing access by an authorized user. A method for securely storing materials is also described.

The present application claims the benefit of U.S. Provisional Application Ser. No. 61/972,258 entitled “Novel Portable Secure Storage Device”, filed Mar. 29, 2014 and U.S. Provisional Application Ser. No. 61/994,120 entitled “Novel Portable Storage Device”, filed May 16, 2014, the contents of each of which are expressly incorporated herein by reference.

### BACKGROUND

Currently, in the United States, more people are taking medications, vitamins, and using psychoactive plants (e.g., marijuana) than ever before. Although people are consuming medications, vitamins, and psychoactive plants for a wide variety of reasons, personal privacy as well as the safety of others pose unique challenges. Generally speaking, personal privacy is a paramount concern. Not only would it be potentially embarrassing if it became known among friends and family that one is taking medication for anxiety, depression, erectile dysfunction, or a myriad of conditions, the legal issues that could arise if it became a matter of public knowledge could be personally catastrophic. Moreover, the safety of others is also a grave concern. It is difficult to understate the danger of a child opening a pill bottle, purse or other container used to store such material that was inadvertently left out in the open. With the rapid increase in the consumption of psychoactive plant material such as marijuana, such issues are becoming ever more prevalent. Effective means of storage are also an issue and of particular concern in regard to so-called “edibles” like marijuana cookies and the like. In addition to the risk of danger and guilt, the potential legal liability that could arise is also staggering. The risk of privacy breach, as well as the risk of access by children and others, is increased outside of the home where safe storage is more difficult, for example, in a car or hotel room or on the beach.

### SUMMARY

A system for securely storing material is disclosed in which the system comprises a portable safe having an interior space for containing material, wherein the portable safe includes a closure for accessing the interior space; wherein the closure comprises an access control system for locking the closure to secure the material within the portable safe, the access control system comprising at least one means for allowing access by an authorized user and denying access by an unauthorized user, whereby the authorized user activates the access control system to open the closure of the portable safe and access the material; and wherein the portable safe further comprises an internal pressure control system.

In another embodiment, a system for securely storing material is provided that comprises at least one canister assembly for containing material, the canister assembly having an opening for accessing the material; and a portable safe having an interior space sized and shaped for retaining the at least one canister assembly, wherein the portable safe includes a closure for accessing the interior space; wherein the closure comprises an access control system for locking the at least one canister assembly within the portable safe, the access control system comprising at least one means for allowing access by an authorized user and denying access by an unauthorized user, whereby the authorized user activates the access control system to open the closure of the portable safe and access the material in the at least one canister assembly; and wherein the portable safe further comprises an internal pressure control system.

In certain aspects, the access control system at least one means is a key lock for manually locking the closure to a closed position. In certain aspects, the access control system comprises at least two means for allowing access by an authorized user and denying access by an unauthorized user. In certain aspects, at least one means comprises a key lock. In certain aspects, the access control system includes an electronic controller, such as a biometric lock.

In certain aspects, the electronic controller includes a biometric system for identifying a specified person, the biometric system providing access to the portable safe upon positively identifying the specified person accessing the access control system.

In certain aspects, the access control system includes a remote wireless unit communicating with the access control system, the remote wireless unit having means for authenticating an authorized user and means for communicating with the access control system upon authenticating the authorized user.

In certain aspects, the remote wireless unit is a mobile phone having an application for authenticating the authenticated user.

In certain aspects, the remote wireless unit is a radio-frequency identification (RFID) tag recognizable by the access control system comprising an RFID reader for authenticating the authenticated user.

In certain aspects, the internal pressure control system includes an air evacuation means and at least one pressure release valve.

In certain aspects, the closure further comprises an electronic port.

In certain aspects, the material comprises a medicinal agent or pharmaceutical composition, and comprises a compound containing one or more cannabinoids, or one or more plant tissue, or the plant tissue is derived from cannabis.

In another embodiment, a system for securely storing a pharmaceutical is provided that comprises at least one canister assembly for containing a pharmaceutical, the canister assembly having an opening for accessing the pharmaceutical; and a portable safe having an interior space sized and shaped for retaining the at least one canister assembly, wherein the portable safe includes a closure for accessing the interior space; wherein the closure comprises an access control system for locking the at least one canister assembly within the portable safe, the access control system having means for allowing access by an authorized user and denying access by an unauthorized user; wherein the closure further comprises an internal pressure control system.

In certain aspects, the internal pressure control system comprises an air evacuation means that evacuates air from the interior space. In certain aspects, the internal pressure control system comprises a pressure release means.

In certain aspects, the access control system includes an electronic controller. In certain aspects, the electronic controller is selected from the group consisting of a biometric system or a means for communicating with a remote wireless unit. In certain aspects, the remote wireless unit is selected from the group consisting of a mobile phone and a radio-frequency identification (RFID) tag.

In certain aspects, the remote wireless unit comprises a means for authenticating an authorized user and means for communicating with the access control system upon authenticating the authorized user.

In certain aspects, the closure is attached to the portable safe by a hinge. The hinge may be a rotatable longitudinal extending pin that allows the closure to rotate.

In certain aspects, the closure and the portable safe have mating threads.

In certain aspects, the canister assembly comprises a container and a lid. In certain aspects, the container is attached to the lid by a hinge. The container may comprise an opening sized to frictionally engage the lid.

In another embodiment, a method for securely storing materials is provided that comprises the steps of placing one or more materials into at least one canister assembly, the canister assembly having an opening for accessing the material and configured to receive a lid; securing the lid to the at least one canister assembly; positioning the at least one canister assembly into a portable safe having an interior space sized and shaped for retaining the at least one canister assembly, wherein the portable safe includes a closure for accessing the interior space, the closure comprising an access control system for locking the at least one canister assembly within the portable safe; and closing the closure and activating the access control system thereby locking the at least one canister assembly within the portable safe.

In certain aspects, the method further comprises the step of evacuating air from the interior space. In certain aspects, air is evacuated by engaging a pump positioned within the closure.

In certain aspects, the method further comprises the step of increasing the pressure within the interior space by activating a pressure release valve positioned within the closure.

In certain aspects, the access control system includes an electronic controller. The electronic controller may include a biometric system for identifying a specified person, the biometric system providing access to the portable safe upon positively identifying the specified person accessing the access control system. The access control system may include a remote wireless unit communicating with the access control system. The remote wireless unit may comprise a means for authenticating an authorized user and means for communicating with the access control system upon authenticating the authorized user. The remote wireless unit may be a mobile phone having an application for authenticating the authenticated user. The remote wireless unit may be a radio-frequency identification (RFID) tag recognizable by the access control system comprising an RFID reader for authenticating the authenticated user. In certain aspects, the remote wireless unit stores or transmits authentication data to another database where the data is monitored, for example, a third party monitors the data and determines whether the portable safe has been accessed within predetermined limits. As such, upon determination that the predetermined limits have not been met, the authenticated user may be informed of the status. In certain aspects, the predetermined limits correspond to a dosage frequency of a medical drug prescription and the data indicate that the authenticated user's access to the portable safe exceeds or does not meet the dosage frequency.

In some embodiments the disclosure provides a container for securely storing material is disclosed in which the container comprises a receptacle having receptacle rim and a receptacle wall portion extending downwardly from an inner side of the receptacle rim, and the receptacle comprising an interior space for holding material; and a closure having a bottom surface comprising a groove that receives the receptacle rim in sealing engagement.

In certain aspects, the container further comprises an access control system that maintains the closure in closed position in relation to the bottom portion to prevent unauthorized access to the material.

In certain aspects, the access control system is a combination lock, and is accessible to a user, and/or is located in the closure.

In certain aspects, the container further comprises an internal pressure control system that evacuates or introduces air from or into the interior space.

In certain aspects, the material comprises a medicinal agent or pharmaceutical composition, a compound containing one or more cannabinoids, one or more plant tissue, and/or plant tissue is derived from cannabis.

In certain aspects, the container comprises insulation that increases the R-value of the container relative to the container lacking the insulation.

In certain aspects, the container comprises a pressure release means that allows air into the interior space. In certain aspects, the pressure release means is a valve.

In certain aspects, the closure is attached to the receptacle by a connection, such as a hinge.

In another embodiment, a method for securely storing materials is provided that comprises the steps of placing one or more materials into the receptacle having receptacle rim and a receptacle wall portion extending downwardly from an inner side of the receptacle rim, and the receptacle comprising an interior space for holding material; and securing the closure having a bottom surface comprising a groove that receives the receptacle rim in sealing engagement to the receptacle.

It is contemplated that any embodiment of a method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternative are mutually exclusive, although the disclosure supports a definition that refers to only alternatives and “and/or.”

As used herein, unless otherwise specified or unless the context otherwise clearly requires, “about” regarding a number or measurement means within 10% of the number or measurement.

As used herein, when the term “range” refers to integers, every integer from the minimum to the maximum values of such range is included. In addition, where multiple ranges are provided to describe a concentration or characteristic, such ranges may be combined.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 is a perspective view of an illustrative embodiment of a system for securely storing material;

FIG. 2A is a perspective view of the portable safe shown in FIG. 1 showing the closure in a opened position according to an embodiment of the invention;

FIG. 2B is a cross-sectional view of the portable safe and closure according to one embodiment;

FIG. 2C is an expanded view of the mechanism of FIG. 2B.

FIG. 3 is a cross-sectional view of an closure attachment means connecting the closure to the portable safe of FIG. 1;

FIG. 4 is a perspective view an illustrative embodiment of an internal pressure control system;

FIG. 5A is a perspective view of an illustrative embodiment of a container for securely storing material;

FIG. 5B is a partial perspective view of showing the bottom of a closure according to one embodiment;

FIG. 6 is a perspective view of an illustrative embodiment of a receptacle;

FIG. 7A is a perspective view of an illustrative embodiment of a container;

FIG. 7B is a perspective view of the container of FIG. 7A showing operation of an embodiment of the air evacuation system;

FIGS. 8A and B are perspective views of an illustrative embodiment of a pressure release mechanism;

FIGS. 9A, 9B, 9C and 9D are perspective views of an illustrative embodiment of a container for securely storing material;

FIG. 10 is a perspective view of an illustrative embodiment of a container for securely storing material in an open position;

FIG. 11 is a perspective view of the container of FIG. 10 in a closed position;

FIG. 12 is a cross-sectional view of an illustrative embodiment of an internal pressure control system;

FIG. 13 is a cross-sectional view of the internal pressure control system of FIG. 12 in a raised position;

FIG. 14 is a perspective partial cut-away view the internal pressure control system of FIG. 12;

FIG. 15 is a perspective partial cut-away view the internal pressure control system of FIG. 13;

FIG. 16 is a perspective partial cut-away and exploded view of the internal pressure control system of FIGS. 14 and 15 showing the gas extraction cylinder;

FIG. 17 is a cross sectional view of an illustrative canister assembly;

FIG. 18 is a cross sectional view of another illustrative canister assembly; and

FIG. 19 is a top plan view of an illustrative embodiment of a divider.

### DETAILED DESCRIPTION

People are naturally curious and like to snoop. However, people also enjoy their privacy, particularly when it comes to medicines and psychoactive substances. They also wish to be responsible and avoid any risk of accidental overdose by curiosity-seekers like children and the uninformed. One way of protecting their privacy while maintaining the safety of others, particularly while away from home, is by storing their medicines and psychoactive substances in a portable safe that is suitable for medicines, vitamins, and psychoactive substances. Such substances and materials, particularly psychoactive flora and parts thereof and materials made therefrom, such as foodstuffs, tend to have a limited shelf life and benefit from storage in airtight containers, particularly under reduced air pressure. The present disclosure therefore relates to personal secure storage devices, and more particularly, but not by way of limitation, to a portable safe for securing medications, vitamins, and psychoactive plant material and the like.

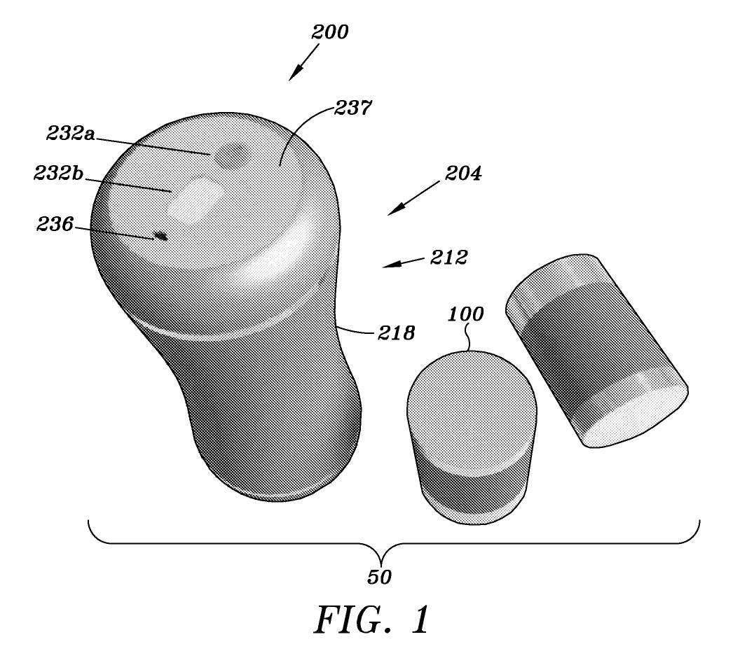

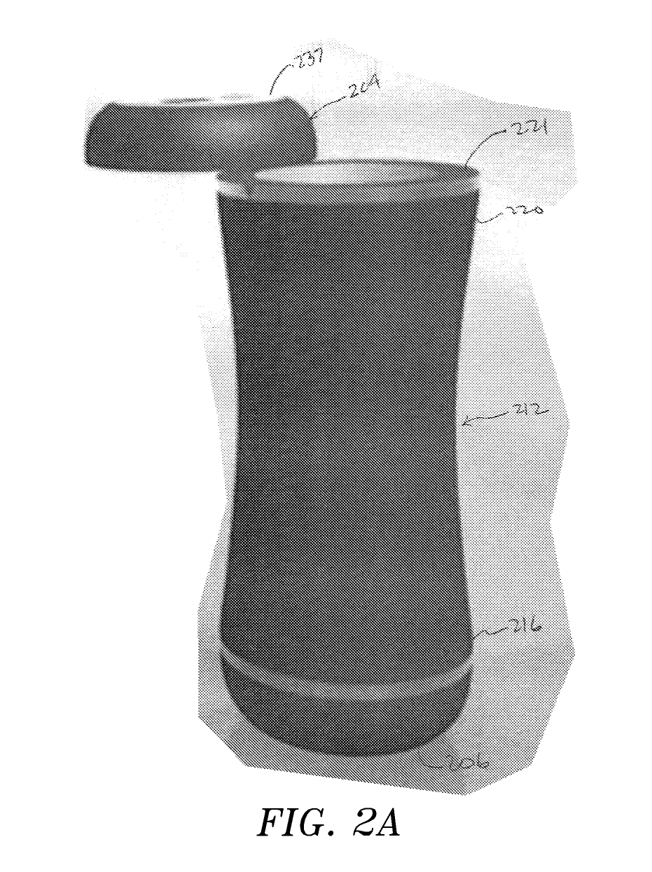

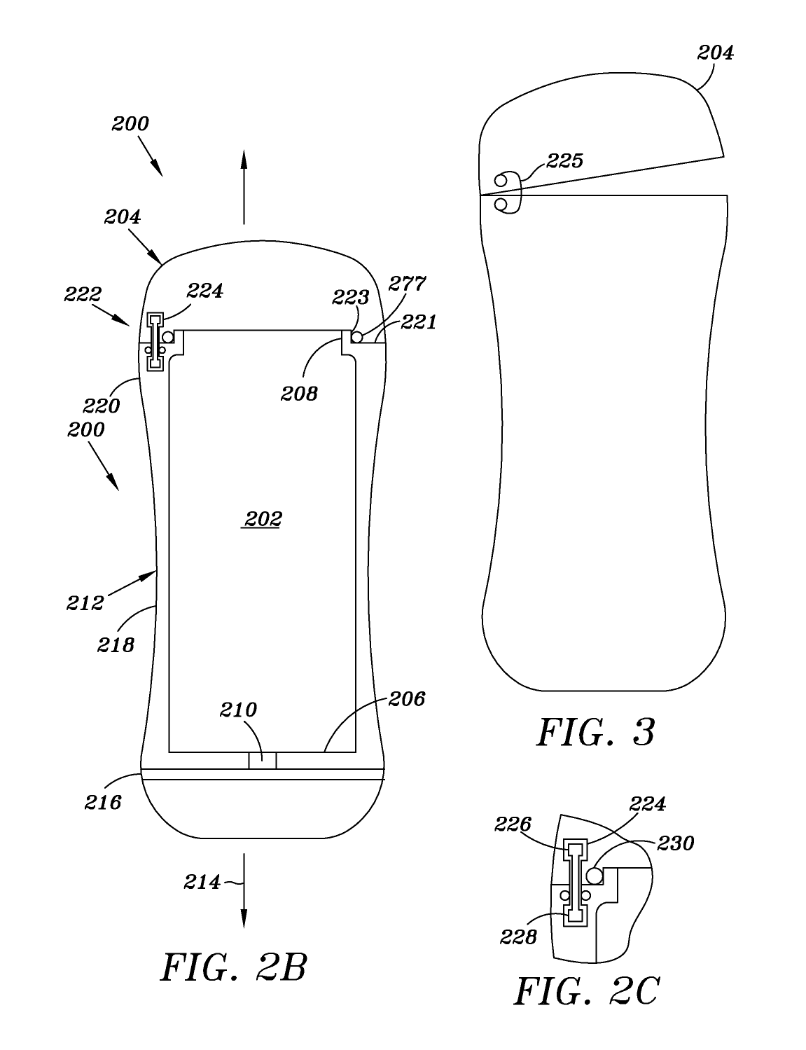

As shown in FIGS. 1 and 2A-2B, the system 50 comprises a portable safe, e.g. a container, 200 having an interior space in which medicines and psychoactive substances may be contained. In some embodiments the container 202 is sized and shaped for retaining at least one canister assembly 100. The container or portable safe 200 includes a closure 204 that is movable between an open position and a closed position, which in the closed position prevents unauthorized access to the at least one canister assembly and material within. In one embodiment the container contains an internal pressure control system, e.g. a vacuum system that forms a seal between the lid and container base. That is, the vacuum system finds use in evacuating the air from the container as well as maintaining a seal. In one embodiment the container contains a lock as described herein as well as vacuum system. In one embodiment the container contains at least one lock and a vacuum system in the lid.

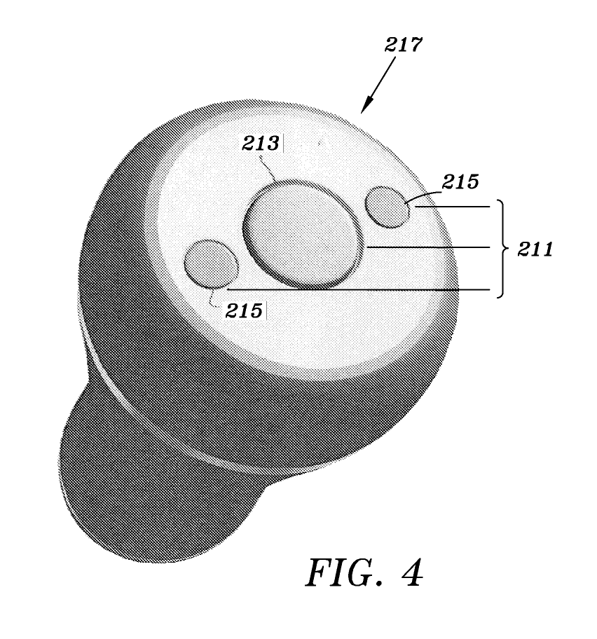

FIG. 2B is a cross-sectional view showing further detail of portable safe 200. In particular, the internal space 202 of the portable safe 200 is shown and can be of substantially varied proportions as long as the space is sufficiently sized to receive at least one canister assembly 100. In one aspect the internal space 202 is substantially cylindrical and has a bottom surface 206 and at least one opening 208 for receiving for receiving the at least one canister assembly 100 and the bottom surface 206 having an opening 210 for the internal pressure control system 211 (see FIG. 4). As shown in FIG. 2B, the body may further include a top surface 221 that may comprise an axially upwardly extending ledge 223 about the opening of the internal space 202, that can be received by a recess in the bottom of the closure 204.

As illustrated in FIGS. 2A and 2B, the outer circumference 212 of the body of the portable safe can also vary along its longitudinal extent 214. For example, the outer circumference may have a wider bottom portion 216, a narrower throat portion 218, and a wider top portion 220. In one aspect, the circumferences of the top and bottom portions may be approximately the same.

The portable safe, closure and at least one canister assembly is preferably injection molded, and may be made of any suitable, durable thermoplastic polymeric material. Acrylic plastics, polycarbonates, durable metals and composites thereof and the like may be used. In some embodiments the interior may be plastic while the exterior may be a different material, such as a metal. In some embodiment the exterior is stainless steel. The lids of the containers can also be made of a variety of materials, such as but not limited to plastics and metals, such as stainless steel. When plastic is used, in some embodiments the plastic will be approved as food grade. The device finds use in a variety of temperatures, such as room temperature to between 0° C.-40° C., or 3° C. to 30° C., or 5° C. to 25° C. Thus the container finds a particular use for storing materials in a refrigerator.

FIG. 2B also depicts an embodiment of the attachment 222 of the closure 204 to the portable safe 200. In particular, a pivotable slidable pin 224 serves as a hinge for the closure and is coaxially positioned along the longitudinal axis 214 and permits the closure 204 to rotate between open and closed positions. The pin may be integral with or fixed attached to the closure, integral with or fixed attached to the body of the portable safe, or a separate piece that connects the closure and the portable safe (as depicted in FIG. 2).

As depicted in FIG. 2B, the pin 224 is held in space 226 in the closure or space 228 the body or both which permits the pin to slide axially as the closure rotates about the pin between open and closed positions as shown also in FIG. 2A, and is particularly helpful when the closure seats into the body as contemplated for some embodiments. A resilient member 230 (e.g., a spring or a pliable, elastomeric, polymeric material) may positioned around the pin to bias the closure in an open position as noted for other embodiments. The expansive force of the spring is preferably less than any vacuum created by the internal pressure control system 211, thereby permitting the activation of the internal pressure control system 211 to substantially form a seal between the closure and the body. To assist in evacuating air by the internal pressure control system, a seal may be placed between the closure and the top of the body. By way of illustration, a seal 227 (such as an O-ring) may be inserted over the top surface of the body and held in place by ledge 223.

FIG. 3 illustrates another embodiment of a hinge for connecting the closure to portable safe 200. For example, in one aspect a hinge 225 is positioned transversely with respect to the longitudinal axis 214 of the body, and as such, permits the hinge side of the closure 204 to remain nearer or substantially adjacent to the top of the body while the opposite side opens away from the internal space. In one aspect the hinge may include opposing prongs that frictionally engage cross bars in the body and the closure respectively.

The ability to automatically physically close the closure after a set amount of time that the user can set. In one embodiment, the closure may be closed via a servomotor activated in responses to a timer. The servomotor and the timer may be contained in the closure or the body of the portable safe. In some embodiments the ability to adjust settings, such as setting or controlling the timer or access to the closure may be performed locally on the actual device or remotely, for instance from a remote control device, such as but not limited to computer, mobile phone, smart phone, tablet, and the like.

The closure may further include lock or latch or similar structure that is received by the top surface 221 of the portable safe 202. In such embodiments, the lock or latch is preferably but not necessarily located on the side of the body of the personal safe that is opposite the hinge.

Referring further to FIG. 1, an illustrative closure 204 comprising access control system 232 shown as elements 232a and 232b, and electronic port 236, where the access control system 232 is displayed on closure top surface 237. Although two embodiments of the access control system are depicted in FIG. 1, more or fewer of the embodiments may be incorporated into the closure design. The access control system 232 comprises at least one means for allowing access by an authorized user and denying access by an unauthorized user where the authorized user activates the access control system to open the closure of the portable safe which thereby allows the user to access material contained in the at least one canister assembly 100.

The access control system 232 may be a key lock (identified as 232a) for manually locking the closure to a closed position, and/or an electronic controller (identified as 232b) for opening the closure by an authorized person after being positively identified.

Key lock 232a may be a back-up for manually locking the closure to a closed position and/or manually unlocking the closure to an open position. The key lock may physically engage the body of the portable safe, such as by extendable pins that are received by the safe body, or alternatively, the key lock may activate a magnetic seal in which case the body will include magnetically chargeable/charged area sufficient to hold the closure in a closed position.

The access control system 232 may comprise an electronic controller 234 that includes an identification reader, such as a biometric scanner. In one embodiment, the user contacts a hand or one or more fingers upon the electronic controller which is then read by biometric device, such as an identification reader (also indicated by 234). The user and any other person's hand or fingerprints may be stored in a memory of the electronic controller. When accessing the access control system, the identification reader matches the stored biometric information with the scanned biometric information (e.g., fingerprints) of the user.

In some embodiments, memory either on the device or in a remote system, such as a hard drive or other storage device in a computer, mobile phone, smart phone, tablet or cloud-based storage, maintains records related to the storage device. These records may include but are not limited to contents of the storage, opening and closing of device, who opened and/or locked and/or closed the device, when and where the device was opened and/or closed. In some embodiments, this information is transmitted to a third party recipient, which may include but is not limited to doctors, nurses, insurance carriers, family members and other care-givers.

In some embodiments closure 204 may optionally comprise electronic port 236 that may be used for wired data transfer and/or for powering the access control system and/or charging a battery supply that a powers the access control system. The port receives a micro USB or similar connector for data and power (e.g., a charging port) as known by those of skill in electronic connectors.

In a further or alternate embodiment of the present invention, the access control system 232 may be actuated to lock or unlock and/or to move the closure 204 to an open or closed position by wired or remote wireless means (e.g. infrared, RFID, BlueTooth™, WiFi, firewire port, USB port, near field communication (NFC), etc.), such as a mobile phone communicating with the access control system. The remote wireless or hard wired unit may contain an phone application by which the user utilizing the mobile phone touch screen inputs a code, fingerprint recognition of the user, or other security application which enables the remote wireless or hard wired unit to authenticate a user, and upon authentication, send a message to the access control system to open or close the safe. Electrical power can be obtained from the access control system to supply electrical power to the mobile device for battery recharge and uninterrupted use.

In a further aspect, the remote wireless unit is a radio-frequency identification (RFID) tag recognizable by the access control system comprising an RFID reader for authenticating the authenticated user. Passive or active tags may be used, although passive tags do not require a battery supply and therefore allow for a smaller design for the encapsulating medium. Therefore, an Active Reader-Passive Tag (ARPT) system is preferred although other systems may be used. In one embodiment, the passive or active tag is a wearable tag. The wearable tag is provided in an encapsulating medium that may take a variety of forms. In one embodiment, the encapsulating medium is a laminar plastic substrate in the form of a card for convenient storage such as in a pocket, wallet, purse or the like. In another embodiment, the encapsulating medium is a bracelet.

The portable safe 200 may further comprise an internal pressure control system 211. FIG. 4 depicts an illustrative internal pressure control system comprising an air evacuation means 213 and at least one pressure release valve 215 that is preferably located on the bottom 217 of the body of the portable safe but may also be included in the closure 204. In addition, the container may contain a pressure indicator. This will allow a user to know whether or not a vacuum has been established. An example of one particularly suitable internal pressure control system is described and illustrated in PCT Publication No. WO 2014/005252 A1, incorporated herein in its entirety.

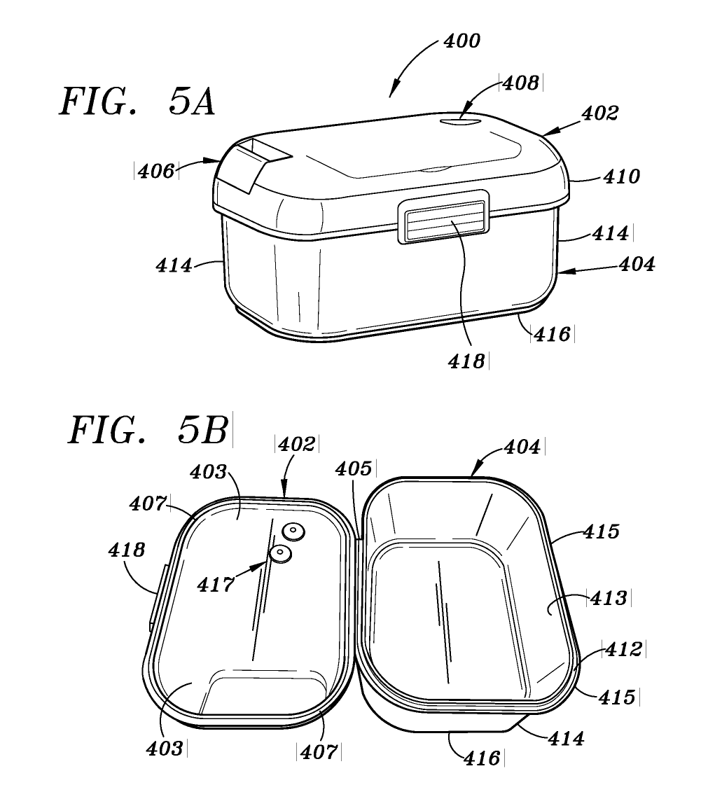

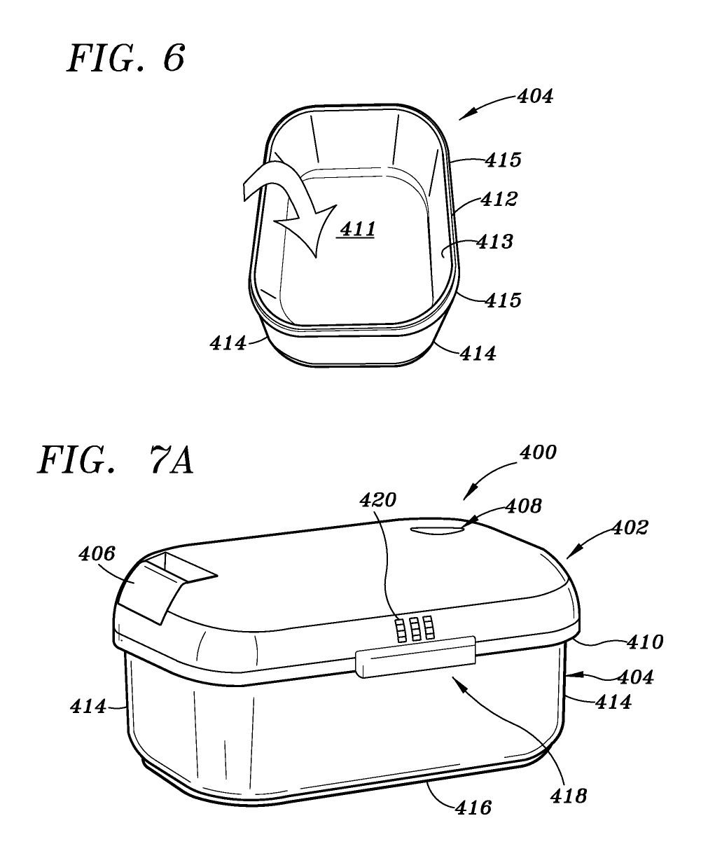

FIGS. 5A, 5B, and 6 depict an illustrative embodiment of a container 400. Container 400 includes closure 402 and receptacle 404. The closure 402 of the embodiment shown in FIG. 5 includes an air evacuation system 406, pressure release means 408, and closure rim 410. Receptacle 404 includes an internal space 411, receptacle rim 412 forming an opening 413, side wall 414 and bottom 416. As shown in FIG. 6, receptacle rim 412 may include an outwardly extending lip 415 positioned slightly below rim 412. As shown in FIG. 5B, in a preferred aspect closure 402 is connected to receptacle 404 by a connector 405 such as a hinge.

In another preferred aspect closure 402 forms an airtight seal with receptacle 404. As such, in one embodiment, closure 402 bottom 403 comprises a groove 407 that sealingly engages receptacle rim 412. In one aspect, the groove further comprises a resilient member seated in the groove that abuts the receptacle rim 412 to further seal the container.

In one aspect container 400 also includes a latch 418 to hold closure 402 in a closed position.

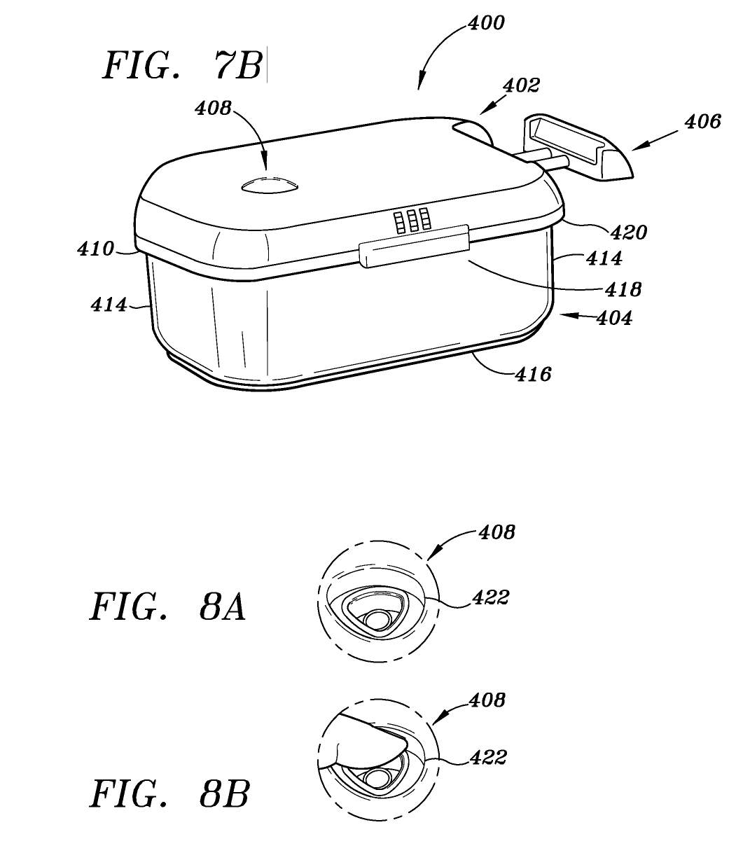

As shown in FIG. 5A, in a preferred aspect air evacuation system 406 comprises a handle that is attached to or in operable communication with a pump positioned within the closure and configured to evacuate air from the internal space 411 via aperture 417 in the bottom 403 of the closure 402 (see FIG. 5B) as the handle portion is moved in and out by the user (for example as shown in FIG. 7B), for example, as described and illustrated in CN201320556820 incorporated herein. With each movement of the handle the air pressure in the sealed container 400 decreases to at least 5, 10, 15, 20, 25, 30 or more millimeters of mercury (mm Hg).

Closure 402 and receptacle 404 may be made any food-grade materials suitable for the storage of pharmaceuticals and plant materials. As such, closure 402 and receptacle 404 may be made of any suitable, durable thermoplastic polymeric material and are preferably injection molded. Acrylic plastics or polycarbonates and other corrosion-resistant materials, such as aluminum, stainless steel, glass and the like may be used. In a preferred aspect the material is clear and colorless, but may comprise any transparency and/or color. The closure and/or the receptacle may be insulated for storage of materials that spoil if otherwise stored at room temperature (i.e., about 72° F.).

The container may include any suitable dimensions for container the materials discussed herein or similar thereto, but preferred dimensions (height×width×length) include but are not limited to 4 inches×9 inches×12 inches, 4 inches×4 inches×3 inches, 6 inches×inches 6 inches×3 inches, and 9 inches×9 inches×4 inches, or dimensions within the ranges defined by those preferred dimensions.

FIGS. 7A and 7B depict an illustrative embodiment of the container 400 that further comprises an access control system 420. In one aspect the access control system is a lock, and in a preferred embodiment the lock is a combination lock. In one embodiment the lock is a combination lock requiring appropriate entry of multiple digits, such as a 3, 4, 5, 6, 7, 8, 9, 10 or more digits for the lock. In some embodiments the lock also requires a password that can optionally be reset as needed. The access control system 420 may comprise an electronic controller that includes an identification reader, such as a biometric scanner. In one embodiment, the user contacts a hand or one or more fingers upon the electronic controller that is then read by biometric device, such as an identification reader. The user and any other person's hand or fingerprints may be stored in a memory of the electronic controller. That is the device comprises memory capable of storing multiple fingerprints. In addition, in some embodiments the device has a battery, which in some embodiments may be a rechargeable battery. When accessing the access control system, the identification reader matches the stored biometric information with the scanned biometric information (e.g., fingerprints) of the user. In a further aspect, the remote wireless unit is a radio-frequency identification (RFID) tag recognizable by the access control system comprising an RFID reader for authenticating the authenticated user. Passive or active tags may be used, although passive tags do not require a battery supply and therefore allow for a smaller design for the encapsulating medium. Therefore, an Active Reader-Passive Tag (ARPT) system is preferred although other systems may be used. In one embodiment, the passive or active tag is a wearable tag. The wearable tag is provided in an encapsulating medium that may take a variety of forms. In one embodiment, the encapsulating medium is a laminar plastic substrate in the form of a card for convenient storage such as in a pocket, wallet, purse or the like. In another embodiment, the encapsulating medium is a bracelet.

FIG. 8 shows an illustrative embodiment of the pressure release means 408, which includes button 422 that when depressed disengages a valve from a mating valve seat to open a passageway to permit air to enter the receptacle internal space 411. The button 422 is preferably made of a resilient, polymeric material that can return to its original shape after being depressed by a user to release the valve and permit air to enter the container.

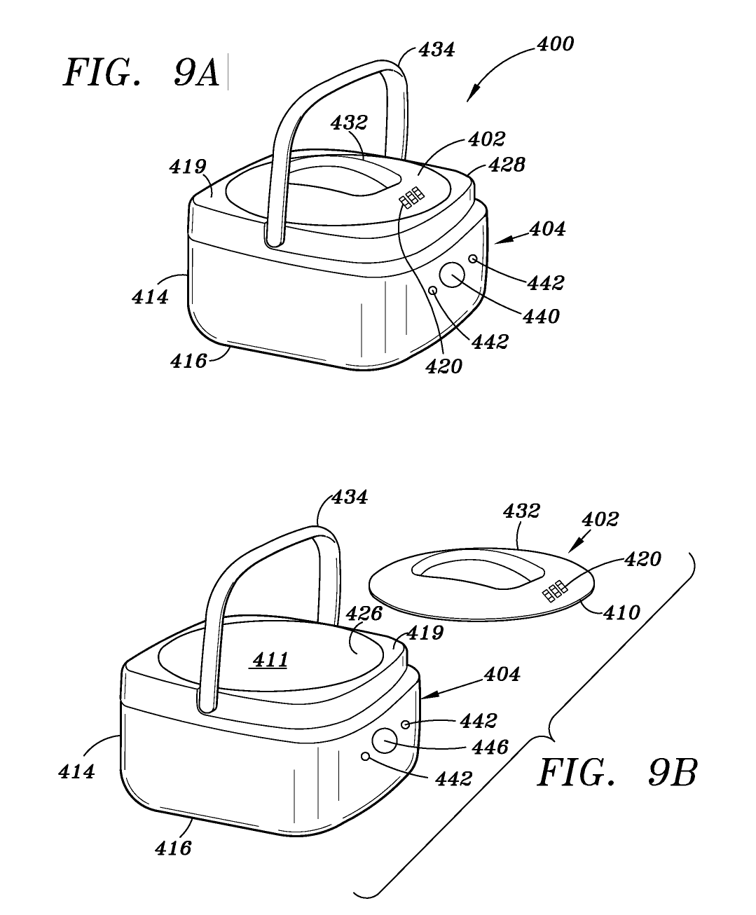

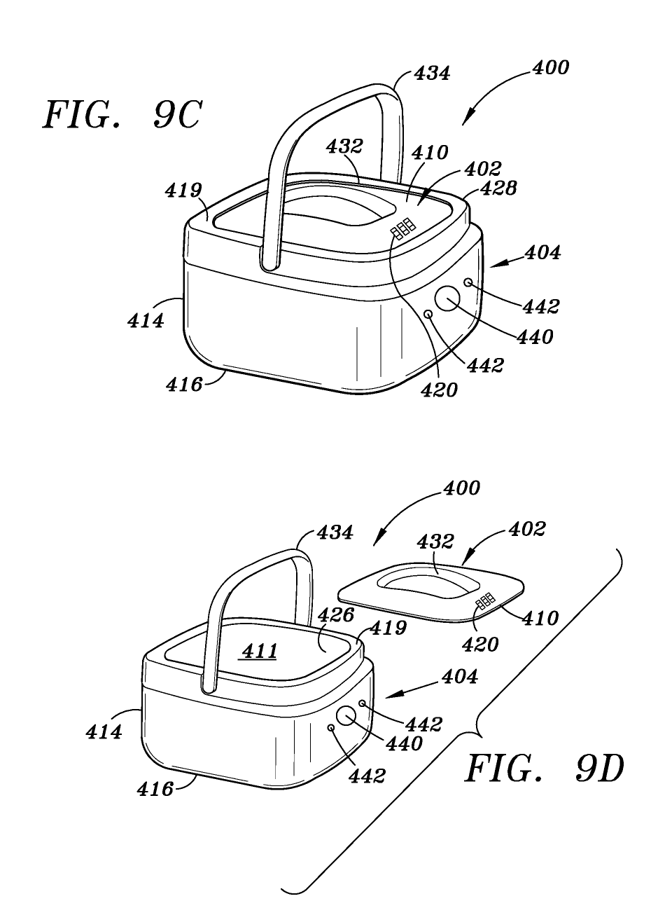

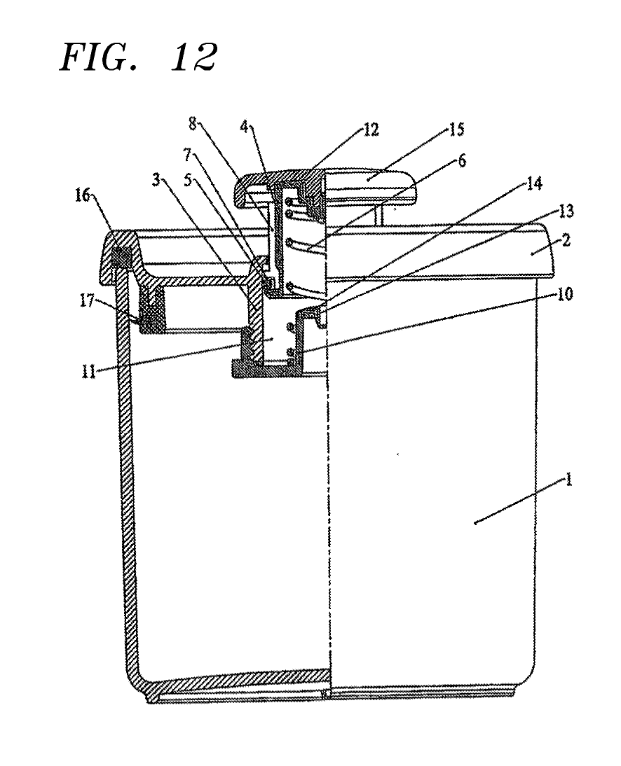

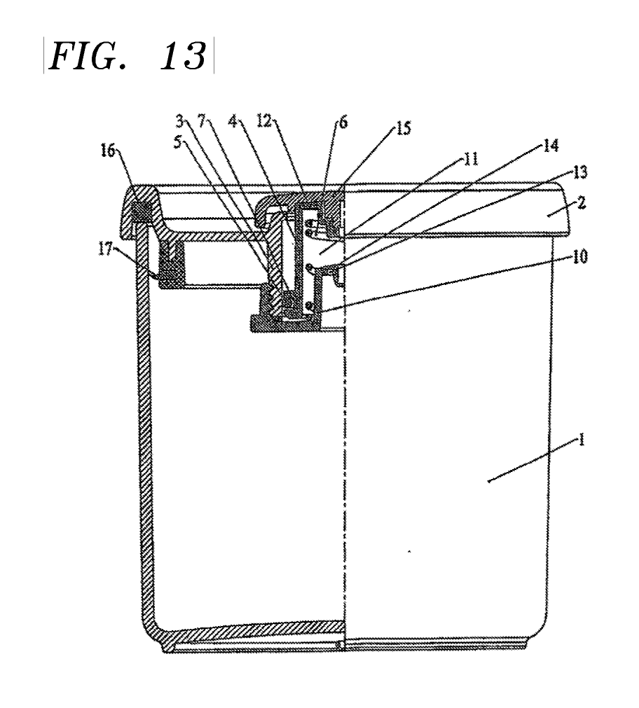

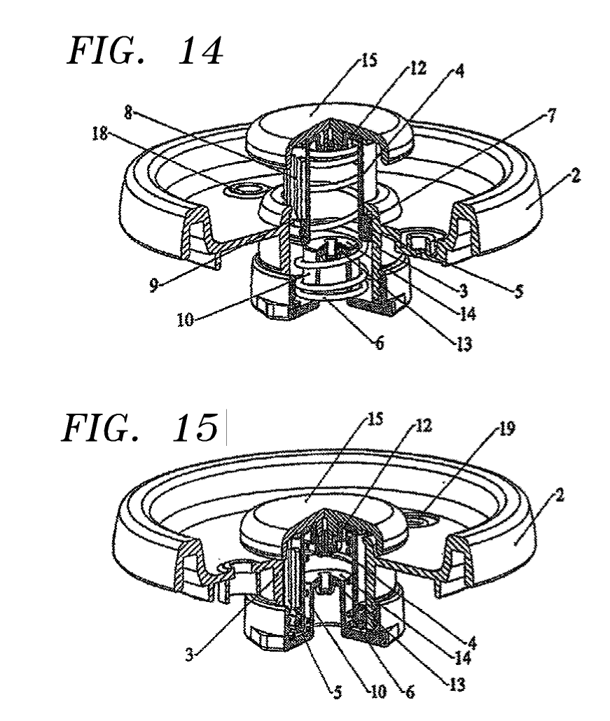

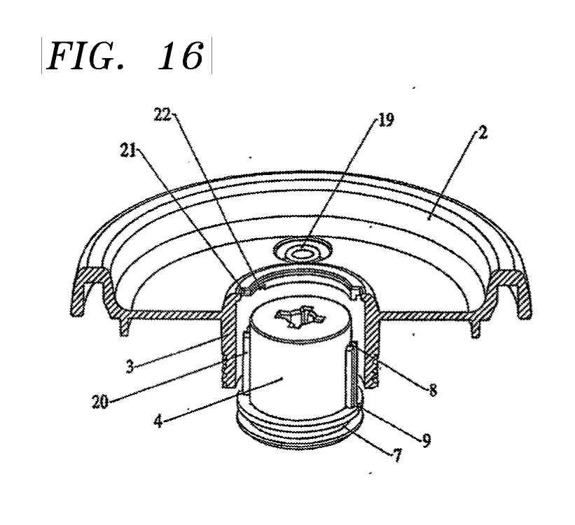

FIGS. 9A and 9B provide another embodiment of container 400. As shown in FIG. 9A, at the top portion 419 of receptacle side wall 414 may extend inwardly horizontally to form a horizontally extending rim 426 that forms a restricted, smaller opening 428 than the receptacle opening 413 shown in FIG. 5. The horizontally extending rim 426 preferably includes a structure (e.g., a lip or groove) for receiving or be received by a corresponding mating structure (e.g. threads or groove) on closure rim 410 of closure 402. As shown in FIG. 9B, closure 402 is configured for removable attachment to receptacle 404, but alternatively closure 402 may be connected to receptacle 404 by a connector such as a hinge. In one aspect, closure 430 may comprise a grip or handle 432, as shown in FIGS. 9A and 9B. While FIGS. 9A and 9B show receptacle 402 with a circular opening and a circular closure rim 410, the opening (and interior space 411) and the closure rim 410 may be square or rectangular as illustrated in FIGS. 9C and 9D. Closure 430 may further include an access control system, such as the access control system 420 shown in FIGS. 7A and 7B. In a preferred embodiment, the containers also comprise an internal pressure control system, such as shown in FIGS. 12-16 and described herein.

Receptacle 404 of FIG. 9 may include a moveable handle 434 positionable between resting and upright positions, and when in the resting position is substantially received by the top portion of the receptacle 404. In one aspect the receptacle has a substantially cuboidal shape, which may have somewhat rounded corners.

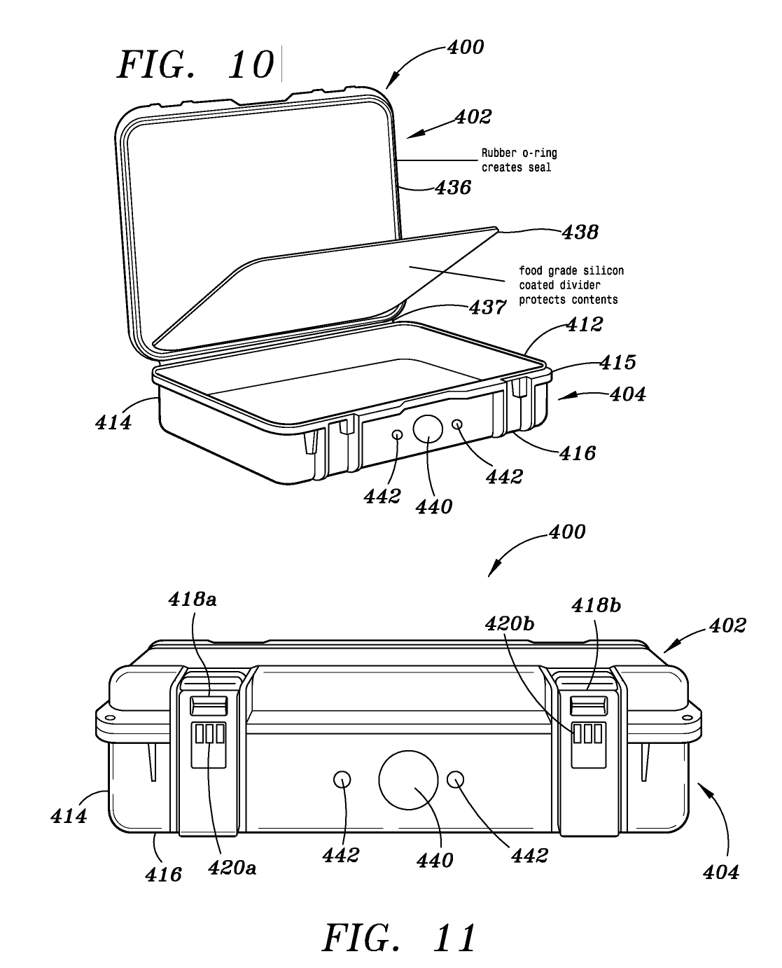

FIGS. 10-11 shows another illustrative embodiment of container 400 that may be in the form of a substantially rectangular case. As shown in FIG. 10, closure 402 is connected to receptacle 404 by a hinge 437. The hinge may be a separate attachment or may be integral with the closure and receptacle. In fact, the closure 402, receptacle 404 and hinge 437 may be a single body, for example, formed by injection molding. In the illustrative embodiment of container 400 shown in FIG. 11, container 400 includes two closures (e.g., latches) 418a, 418b, each with an access control system 420a, 420b. Additional latches and access control systems may be incorporated into the container.

In one aspect, closure rim 412 is made of a resilient material that forms a seal when the closure is closed and the material is compressed against the receptacle 404. In one aspect, the closure rim includes a groove for receiving a separate resilient member 436 (e.g., O-ring) for forming a seal when in the closed position. The resilient member may be made from a suitable elastic material. Examples of suitable elastic materials including natural latex rubber in addition to synthetic materials, such as styrene ethylene butadiene, styrene butadiene, polychloroprene (Neoprene), nitrile rubber, vinyl, and the like.

As depicted in the embodiment shown in FIG. 10, the container 400 may further comprise a divider 438 for protecting materials stored in receptacle 404. In a preferred aspect the divider is substantially the same dimensions as the width and depth of the internal space 411 as shown, although other dimensions may be desirable. The divider may further include attached thereto pockets and storage spaces for additional materials.

FIG. 10 also depicts an illustrative internal pressure control system comprising an air evacuation control 140 and at least one pressure release valve 442 that is preferably located in the side wall 414 of the receptacle 404 but may also be included in the closure 402. An example of one particularly suitable internal pressure control system is described and illustrated in PCT Publication No. WO 2014/005252 A1, incorporated herein in its entirety.

One embodiment of an internal pressure control system is shown in FIGS. 12-16. As shown, an end of the portable safe 200 comprises an internal pressure control system comprising a gas extraction cylinder 4, a piston ring 5 and a spring 6. The piston ring is mounted in an annular recess 7 of the gas extraction cylinder and is connected to the cylinder wall of the cylinder body, the height of the annular recess being larger than the thickness of the piston ring, and the outer wall of the gas extraction cylinder is provided with an exhaust groove 8 in communication with the annular recess through a notch 9. The lower end of the cylinder body is provided with an inner cylinder 10, and the spring is fitted over the outer side of the inner cylinder and upwardly supports same, and is connected to a cylinder cover 12 of the gas extraction cylinder, which is in turn covered by cover/button 15 (visible as air evacuation means 213 in FIG. 4). A gas extraction chamber 11 is formed by the enclosing of the inner cylinder 10, the gas extraction cylinder 4 and the cylinder body 3 of the container cover; when the gas extraction cylinder 4 is moved upward, the piston ring is located at the lower side of the annular recess to seal off the gas extraction chamber, and gas in the container enters the gas extraction chamber 11 through a gas outlet hole 13 and a check valve 14 to form a gas extraction structure; and when the gas extraction cylinder 4 is moved downward, the piston ring is located at the upper side of the annular recess, the gas outlet hole is closed by the check valve, and the gas in the gas extraction chamber is in communication with the notch 9 and the exhaust groove 8 through the annular recess 7 to form a gas exhaust structure. While shown as positioned within an embodiment of closure 204, it will be understood that it may additionally or alternatively be located in the bottom 217 of the portable safe 200.

For the embodiment where the pressure control system is in the bottom of the portable safe, passageway 210 permits air to be evacuated from the internal space 202 containing at least one canister assembly 100.

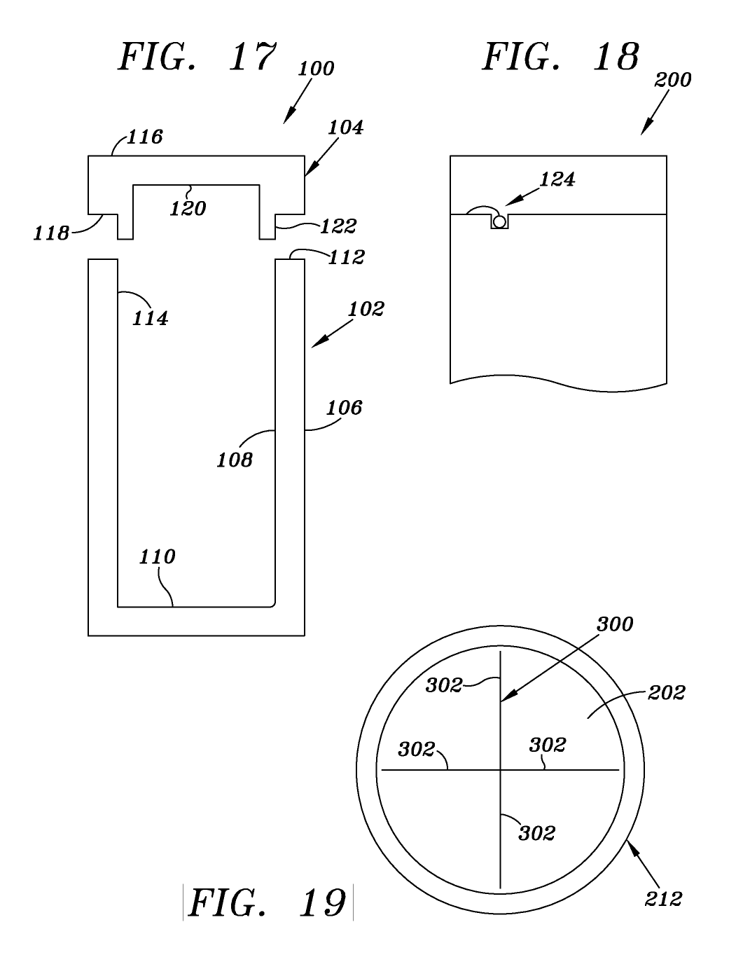

Referring to FIG. 17, an illustrative canister assembly 100 is provided that includes a container 102 and a lid 104. The container 102 has an outer wall 106 that is substantially received by the internal space 202 of the portable safe 200, an inner wall 108, a bottom 110 and a top edge or surface 112, with the inner wall 108 and bottom 110 defining an opening 114 at one end for accessing the material. The lid 104 has a top surface 116, a bottom surface 118 having a recess 120 and further comprising an axially extending rim 122 along the recess's perimeter that extends downwardly for frictional engagement by the inner wall 108 of the container 102. Alternatively, the top surface 112 of the container 102 may include an upwardly axially extending rim for frictional engagement by lid's recess 120, where the lid bottom surface would lack a downwardly extending rim.

As shown in FIG. 18, another exemplary canister assembly 100 is substantially cylindrical and may be received by the internal space 202 of the portable safe 200, for example, as shown in FIG. 2. In this embodiment, the lid 104 may lack a downwardly extending member such that in a closed position the bottom edge 118 of the lid may substantially abut against the top edge or surface 112 of the container 102, but is connected to the container by a hinge mechanism 124, such as any described previously for the closure and portable safe.

In another embodiment, materials desired to be stored may be stored directly in the personal safe without further containment within at least one canister assembly 100.

Moreover, dividers, drawers and the like may be inserted within internal space 202 instead of or in addition to at least one canister assembly 100. For example, FIG. 19 illustrates in top plan view an illustrative embodiment of a divider 300 that separates the longitudinal extent of the internal space 202 into four compartments. Of course, fewer or more compartments may be provided by omission or addition of separators 302. The divider may also take the form of a drawer and the like.

Materials that may be contained in canister assembly 100 or directly in internal space 202 include medicinal agents, pharmaceutical composition, plants or plant parts or derivatives thereof, compounds produced from plants or plant parts. In particular, cannabinoids and plant tissue derived from cannabis may be stored in canister assembly 100.

With materials stored in at least one canister assembly 100 and the at least one canister assembly being stored in the internal space 202 of the portable safe 200, with the closure 204 in the closed position, the materials are securely and safely transportable. The portable safe may be transported to any location, as it is capable of being carried by hand.

While exemplary embodiments are described above, it is not intended that these embodiments describe all possible forms. The words used in the specification are words of description rather than limitation, and it is understood that various changes may be made without departing from the scope of the disclosure. As previously described, the features of various embodiments may be combined to form further embodiments of the invention that may not be explicitly described or illustrated. While various embodiments may have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to: cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

Furthermore, the figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the principles of the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, may be desired for particular applications or implementations.

The previous detailed description is of a small number of embodiments for implementing the invention, and is not intended to be limiting in scope. One of skill in the art may envisage methods and variations used to implement the principles of the invention in other areas than those described in detail herein.

1. A system for securely storing material, the system comprising:
a container having an interior space, wherein the container includes a closure for accessing the interior space;
wherein the closure comprises an access control system for locking the closure, the access control system comprising at least one means for allowing access by an authorized user and denying access by an unauthorized user; and
wherein the container further comprises an internal pressure control system.

2. The system according to claim 1, wherein the access control system at least one means is a key lock for manually locking the closure to a closed position, a combination lock or an electronic controller.

3. The system according to claim 1, wherein the access control system comprises at least two means for allowing access by an authorized user and denying access by an unauthorized user.

4. The system according to claim 3, wherein said at least two means are selected from the group consisting of a key lock, a combination lock and an electronic controller.

5. The system according to claim 1, wherein the access control system includes an electronic controller.

6. The system according to claim 5, wherein the electronic controller includes a biometric system for identifying a specified person, the biometric system providing access to the portable safe upon positively identifying the specified person accessing the access control system.

7. The system according to claim 1, wherein the access control system includes a remote wireless unit communicating with the access control system, the remote wireless unit having means for authenticating an authorized user and means for communicating with the access control system upon authenticating the authorized user.

8. The system according to claim 7, wherein the remote wireless unit is a mobile phone having an application for authenticating the authenticated user.

9. The system according to claim 7, wherein the remote wireless unit is a radio-frequency identification (RFID) tag recognizable by the access control system comprising an RFID reader for authenticating the authenticated user.

10. The system according to claim 1, wherein the internal pressure control system includes an air evacuation means and at least one pressure release valve.

11. The system according to claim 1, wherein the closure further comprises an electronic port.

12.-16. (canceled)

17. The system according to claim 1, wherein the internal pressure control system comprises an air evacuation means that evacuates air from the interior space.

18. The system according to claim 1, wherein the internal pressure control system comprises a pressure release means.

19. (canceled)

20. The system according to claim 5, wherein the electronic controller is selected from the group consisting of a biometric system or a means for communicating with a remote wireless unit.

21. The system according to claim 20, wherein the remote wireless unit comprises a means for authenticating an authorized user and means for communicating with the access control system upon authenticating the authorized user.

22. The system according to claim 21, wherein the remote wireless unit is selected from the group consisting of a mobile phone and a radio-frequency identification (RFID) tag.

23.-28. (canceled)

29. A method for securely storing materials, the method comprising the steps of:
placing one or more materials into the container of claim 1;
closing the container and activating the access control system thereby locking the container; and
evacuating air from the interior space of the container.

30. (canceled)

31. The method according to claim 29, wherein air is evacuated by engaging a pump positioned within the closure.

32. The method according to claim 29, further comprising the step of increasing the pressure within the interior space by activating a pressure release valve positioned within the closure.

33. The method according to claim 29, wherein the access control system includes an electronic controller.

34. The method according to claim 33, wherein the electronic controller comprises a biometric system for identifying a specified person, the biometric system providing access to the portable safe upon positively identifying the specified person accessing the access control system.

35. The method according to claim 29, wherein the access control system includes a remote wireless unit communicating with the access control system.

36. The method according to claim 35, wherein the remote wireless unit comprises a means for authenticating an authorized user and means for communicating with the access control system upon authenticating the authorized user.

37. The method according to claim 36, wherein the remote wireless unit is a mobile phone having an application for authenticating the authenticated user.

38. The method according to claim 36, wherein the remote wireless unit is a radio-frequency identification (RFID) tag recognizable by the access control system comprising an RFID reader for authenticating the authenticated user.

39. The method according to claim 35, wherein the remote wireless unit stores or transmits authentication data to another database, wherein the data is monitored.

40. The method according to claim 39, wherein a third party monitoring the data determines whether the portable safe has been accessed within predetermined limits.

41. The method according to claim 40, wherein upon determination that the predetermined limits have not been met, the authenticated user is informed of the status.

42. The method according to claim 41, wherein the predetermined limits correspond to a dosage frequency of a medical drug prescription and the data indicate that the authenticated user's access to the portable safe exceeds or does not meet the dosage frequency.

43. (canceled)

44. A container for storing material, the container comprising:
a receptacle having receptacle rim and a receptacle wall portion extending downwardly from an inner side of the receptacle rim, the receptacle comprising an interior space for holding material; and
a closure having a bottom surface that sealingly engages the receptacle rim, wherein said container further comprising an access control system that maintains the closure in closed position in relation to the bottom portion to prevent unauthorized access to the material.

45. The container according to claim 44, wherein the access control system is selected from the group consisting of a combination lock and an electronic controller.

46.-47. (canceled)

48. The container according to claim 44, further comprising an internal pressure control system.

49. The container according to claim 48, wherein the closure comprises the internal pressure control system that evacuates air from the interior space, thereby reducing the internal pressure of the container.

50.-53. (canceled)

54. The container according to claim 44, wherein the container comprises insulation that increases the R-value of the container relative to the container lacking the insulation.

55. The container according to claim 44, wherein the container comprises a pressure release means that allows air into the interior space.

56. The container according to claim 55, wherein the pressure release means is a valve.

57. The container according to claim 44, wherein the closure is attached to the receptacle by a connector.

58. The container according to claim 57, wherein the connector is a hinge.

59. A method for securely storing materials, the method comprising the steps of:
placing one or more materials into the receptacle of claim 44; and
securing the closure to the receptacle.

60. The method according to claim 59, further comprising the step of evacuating air from the interior space.

61. The method according to claim 60, wherein air is evacuated by an air evacuation system.

62.-66. (canceled)

67. The method according to claim 59, further comprising the step of securing the closure to the receptacle to prevent access by an unauthorized user.

68. The method according to claim 67, wherein the closure is secured to the receptacle by an access control system.

69. The method according to claim 68, wherein the access control system is selected from the group consisting of a combination lock and an electronic controller.

70. (canceled)

71. The system of claim 2, wherein the electronic controller includes a biometric system for identifying a specified person.

72. The system of claim 4, wherein the electronic controller includes a biometric system for identifying a specified person.
